(19) United States
(12) Patent Application Publication
(10) Pub. No.: US 2008/0082268 A1
(43) Pub. Date: Apr. 3, 2008

(54) PREDICTING THE FORMATION OF INTENSE HURRICANES

(75) Inventors: Alexander Soloviev, Hollywood, FL (US); Tom Gustafson, Wellington, FL (US)

Correspondence Address: FELDMANGALE, P.A., ONE BISCAYNE TOWER , 30TH FLOOR , 2 SOUTH, BISCAYNE BOULEVARD, MIAMI, FL, 33131-4332, US

(73) Assignee: NOVA SOUTHEASTERN UNIVERSITY, Fort Lauderdale, FL (US)

(21) Appl. No.: 11/859,271

(22) Filed: Sep. 21, 2007

Related U.S. Application Data
(60) Provisional application No. 60/826,387, filed on Sep. 21, 2006.

(51) Int. Cl. G01W 1/00

(52) U.S. Cl. 702/3

(57) ABSTRACT

A method of predicting the formation of strong hurricanes using energetic internal oscillations in an ocean.

### CROSS-REFERENCE TO RELATED APPLICATIONS

The present application claims priority benefit under 35 U.S.C. §119(e) of U.S. Provisional Patent Application Ser. No. 60/826,387 filed Sep. 21, 2006. The disclosure this application is incorporated herein by reference.

### FIELD OF THE INVENTION

This invention relates generally to hurricane prediction, and more particularly, to a method of predicting the formation of strong hurricanes using energetic internal oscillations in an ocean.

### BACKGROUND OF THE INVENTION

Damage caused annually to the world economy by catastrophic tropical cyclones, typhoons, and hurricanes amounts to thousands of human lives and tens of billions of dollars. It is well known that timely forecasts are critical to reducing damages caused by such natural disasters.

Despite notable improvement of hurricane models, short-term hurricane forecasts still represent a problem even for a period of one week. At the present time, there is no reliable tool for a mid-range hurricane forecast, e.g., from one week to one month. Accordingly, there is a need in the art for the accurate, mid-range prediction of major hurricanes.

### SUMMARY OF THE INVENTION

In view of the above problems the present invention was developed. The present invention provides a novel method for predicting favorable conditions for the formation of intense hurricanes using energetic internal oscillations to indicate when too much warm water is accumulated in a hurricane prone region (e.g., the tropical Atlantic region). These energetic internal oscillations serve as a sensor for mid-range forecast of intense hurricanes.

### BRIEF DESCRIPTION IF THE DRAWINGS

The accompanying drawings, which are incorporated in and form a part of the specification, illustrate the embodiments of the present invention and together with the description, serve to explain the principles of the invention. In the drawings:

FIG. 1. This figure is a schematic representation of the Atlantic subtropical gyre and the western boundary current system. Location of the coastal observatory in the Straits of Florida is indicated by the black arrow. Due to dependence of the Earth rotation effects on latitude, the oceanic gyre takes an asymmetric shape including a strong and narrow western boundary current passing through the Gulf of Mexico as the Loop Current, through the Straits of Florida as the Florida Current, and exits the Straits of Florida as the Gulf Stream.

FIG. 2. This figure illustrates a composite plot of the seasonal and interannual change of the spectral energy of the velocity internal oscillation within the 8 to 12.5 hour band. (NSU OC bottom ADCP (acoustic Doppler current profilers) mooring at 11-m isobath, 26°04.23′N, 80°05.65′W).

FIG. 3. This figure shows the amplitude of the velocity internal oscillation within the 8 to 12.5 hr band during the summers of 1999-2005. (NSU OC bottom ADCP mooring at 11-m isobath, 26°04.23′N, 80°05.65′W).

FIG. 4. This figure depicts the velocity spectra (two upper bold curves) compared to the spectra of barotropic tidal velocities (two lower bold curves) calculated from the sea level spectrum using the long wave gravity theory. Note that this theory does not work in the vicinity of the inertial period, which is equal to ˜27 hours on the latitude of Dania Beach Fla.; the spectra of barotropic tidal velocities can be calculated only for periods less than 27 hours. Thin lines are 95% confidence limits. Detail tidal constituents near 24 hrs (K₁, O₁ and P₁) and near 12 hrs (M₂, S₂ and N₂) are marked by vertical dashes. The 10 hr period is also indicated by a red vertical dashed line. (NSU OC bottom ADCP mooring at 11-m isobath, 26°04.23′N, 80°05.65′W).

Table 1. This table shows the time difference between the peak of energetic internal oscillations in the Straits of Florida and the first time hurricanes achieved equivalent Category 5 status ranges from one to four weeks.

FIG. 5. This figure illustrates power dissipation by hurricanes and the equivalent Category 5 level dissipation. The straight horizontal line indicates the equivalent Category 5 level dissipation. The hurricanes that achieved the equivalent Category 5 status are marked.

### DETAILED DESCRIPTION OF THE PREFERRED EMBODIMENTS

In an embodiment, the present invention provides a novel method of predicting the occurrence of intense hurricanes, comprising:
(a) recording internal oscillations in a body of water in or adjacent to a hurricane-prone region to determine its natural period of internal seiching;
(b) measuring the intensity of the internal oscillations in the body of water at its natural period of internal seiching; and,
(c) correlating the intensity measurements with the subsequent formation of hurricanes.

In another embodiment, the present invention provides a novel method, wherein the hurricane being predicted is an equivalent Category 5 hurricane or a series of equivalent Category 5 hurricanes.

In another embodiment, the present invention provides a novel method, wherein the body of water, comprises: a tropical warm water exhaust current (which is the western boundary current as a part of an oceanic subtropical gyre).

In another embodiment, the present invention provides a novel method, wherein the body of water is the Straits of Florida.

In another embodiment, the present invention provides a novel method, wherein the natural period of internal seiching is about 10 hours.

In another embodiment, the present invention provides a novel method, wherein the correlating is performed against a data set of at least 3, 4, 5, 6, 7, 8, 9, or 10 years of historical data from the same body of water.

In another embodiment, the present invention provides a novel method, wherein when intensity measurements indicate the potential formation of an intense hurricane, observing the atmospheric conditions in the hurricane-prone region to assist in determining the accuracy of the forecast.

In another embodiment, the present invention provides a novel method, wherein satellite information on the warm pool size and location is used to assist in pinpointing the time and location of the hurricane formation.

In another embodiment, the present invention provides a novel method of obtaining data for predicting hurricanes, comprising:
(a) locating a body of water that internally oscillates in response to anomalous horizontal pressure gradients that develop in the upper layer of a tropical ocean during a hurricane season;
(b) placing sensors within the body of water that are capable of recording and transmitting data sufficient to measure internal seiching in the body of water;
(c) measuring internal oscillations in the body of water to determine its natural period of internal seiching; and,
(d) measuring the intensity of the internal oscillations in the body of water during its natural period of internal seiching.

In another embodiment, the present invention provides a novel method, further comprising:
(e) comparing the annual intensity of the natural period of internal seiching with previous years' annual intensity data to determine when a large increase in intensity is observed.

In another embodiment, the present invention provides a novel method, wherein the data, comprises: data from the body of water relating to current, sea level, temperature, and salinity.

In another embodiment, the present invention provides a novel hurricane predictive data set, comprising: a computer readable medium, comprising: a data set derived by a process, comprising:
(a) recording internal oscillations in a body of water in a hurricane-prone region to determine its natural period of internal seiching;
(b) measuring the intensity of the internal oscillations in the body of water at its natural period of internal seiching; and,
(c) correlating the intensity measurements with the subsequent formation of hurricanes.

In another embodiment, the present invention provides a novel data set, wherein the hurricane is an equivalent Category 5 hurricane or a series of equivalent Category 5 hurricanes.

In another embodiment, the present invention provides a novel data set, wherein the body of water, comprises: a tropical warm water exhaust current (which is a western boundary current as a part of an oceanic subtropical gyre).

In another embodiment, the present invention provides a novel data set, wherein the body of water is the Straits of Florida.

In another embodiment, the present invention provides a novel data set, wherein the natural period of internal seiching is about 10 hours.

In another embodiment, the present invention provides a novel data set, wherein the correlating is performed against a data set of at least 3, 4, 5, 6, 7, 8, 9, or 10 years of historical data from the same body of water.

During the summer and fall seasons, a large body of warm water with the surface temperature exceeding 28.5° C., the Atlantic Warm Pool area, appears in the Gulf of Mexico, the Caribbean Sea, and the western tropical North Atlantic. The Atlantic Warm Pool has a prominent seasonal cycle, anomalously large fluctuations in its area during summer and fall, and is affected by the Atlantic Multidecadal Oscillation. The Atlantic Warm Pool is in the path of Atlantic hurricanes. The presence of an anomalously large warm pool leads to the suppression of the tropospheric vertical wind shear, which is favorable for atmospheric convection leading to hurricane formation and intensification. An anomalously large warm pool also tends to increase convective available potential energy due to the increased air-sea heat and water vapor fluxes (which are the “fuel” for hurricane development and intensification).

The Atlantic Warm Pool is located on the southwest flank of and is a part of the Atlantic Subtropical Gyre. A tropical warm water exhaust current (which, according to the oceanographic terminology, is called the western boundary current as a part of the oceanic subtropical gyre) is a current of water that typically moves warm water from warm regions into cool regions. This current during hurricane seasons is often not capable of moving enough excess heat from the warm region to prevent the formation of a hurricane. This current is also susceptible to baroclinic cross-stream seiching in the straits with non-uniform bottom topography when warm water builds up upstream and exerts pressure on the current.

Due to the water expansion with temperature, the warm pool area is characterized by sea-surface level increase. An anomalously large Atlantic Warm Pool results in sea level anomaly and anomalously large horizontal pressure gradients in the Atlantic Subtropical Gyre. It is well known that sea-level disturbances propagate in the ocean with the speed of c=(gd)^{1/2}, which is about 200 m s⁻¹ for acceleration due to gravity g=9.8 m s⁻² and typical depth of the ocean d=4000 m. As a result, the adjustment of the horizontal pressure gradient at the entrance to the Straits of Florida because of changes in the state of the Atlantic Warm Pool can occur on time scale of 1 day, which is small, compared to the typical time scale of the hurricane development of 1 week. This provides a physical mechanism for a rapid propagation of the information on anomalous states of the Atlantic Warm Pool to the Straits of Florida via the Atlantic Subtropical Gyre, which adds a predictive value to processes in the Straits of Florida for the hurricane forecasting in the Gulf of Mexico, the Caribbean Sea, and the western tropical North Atlantic. Thus, it can be useful to monitor (e.g., size, location, temperature, sea-surface level, horizontal pressure gradients, etc.) the Atlantic Warm Pool to determine when conditions are favorable for the formation of intense hurricanes.

The examples provided in the definitions present in this application are non-inclusive unless otherwise stated. The definitions include but are not limited to the recited examples.

Internal oscillations refer to oscillations in a body of water that are non-surface oscillations (e.g., standing waves that occur below the surface of the body of water).

Internal seiching refers to internal oscillations or a standing wave (e.g., a wave that remains in a constant or near constant position) that occurs below the surface of a closed or semi-closed body of water (e.g., the Straits of Florida). Internal seiching typically occurs through natural phenomena. For example thermal and/or salinity stratification can result in layers of different densities that oscillate relative to one another. Internal seiching is sometimes referred to in the oceanographic literature as baroclinic seiching.

Seiching period refers to a length of time during which internal seiching occurs.

Hurricane is a tropical storm that includes, but is not limited to, hurricanes, cyclones, and typhoons.

During analysis of a six-year observational data set, including the 1999-2005 hurricane seasons, from an ocean observatory established in 1999 on the Dania Beach, Fla. shelf, it was discovered that the energetic internal oscillations with approximately a 10-hour period previously reported at this location precede the formation of strong hurricanes in the tropical Atlantic region (including the Caribbean Sea and the Gulf of Mexico) with a lead time from approximately 1, 2, 3, to 4 weeks. It has also been discovered that this phenomenon is related to the fact that the flow dynamics in the Straits of Florida may reflect the state of the whole North Atlantic gyre and, in particular, contain useful information about the conditions favorable for hurricane formation and intensification.

The 10 hour period is close to a natural period of the cross-stream internal seiching in the Florida Current, which is a highly baroclinic current confined to flow over a rapidly changing non-uniform topography between Florida and the Bahamas. The Florida Current is a part of the subtropical ocean gyre, which helps to redistributes the incoming heat between low and high latitudes. During summer time the subtropical oceanic gyre and the normal atmospheric circulation are not able to remove the excess warm water fast enough from the tropics before hurricane formation process is initiated. In such case the excess heat is removed from the system via hurricanes. Due to dependence of the Earth's rotational effects on latitude, the oceanic gyre takes an asymmetric shape including a strong and narrow western boundary current passing through the Gulf of Mexico as the Loop Current and through the Straits of Florida as the Florida Current (referenced as the Gulf Stream, a term used to describe the Florida Current when it leaves the Straits of Florida).

The heat accumulating in the upper ocean (approximately 100 meters) of the tropical Atlantic region during summer time affects the sea level elevation and, hence, the horizontal pressure gradients driving the Florida Current. The Straits of Florida respond to excess pressure gradients in a resonant manner developing 10 hr energetic internal oscillations.

When too much heat is accumulated in the tropical ocean and the western boundary current system and the normal atmospheric circulation are unable to effectively transport it to higher latitudes, hurricanes develop as a mechanism of removing excess heat from the tropical ocean. Prior to intense hurricane formation, the western boundary current signal the predisposition of the tropical ocean to support hurricane formation in the tropical Atlantic region.

The 10-hour energetic internal oscillations are detected through use of an environmental array located at the ocean observatory in Dania Beach, Fla. The environmental array consists of, but is not limited to, a mooring array with acoustic Doppler current profilers (ADCP), a combination of temperature and salinity sensors, and data recording and transmission system.

The location of the sensors may be important in order to be able to detect the internal oscillations of a body of water and determine its seiching period. For example one can measure the intensity of a baroclinic cross-stream seiche in the Straits of Florida using an oceanographic mooring or system of moorings in the vicinity of the Gulf Stream front (typically located from a few miles to tens of miles off the east Florida shelf). Since the Gulf Stream front can migrate depending on season a line of moorings across the Straits is expected to be more effective than just a single mooring.

The present invention also covers the use of remote sensing methods. For example the oscillations of the Gulf Stream front associated with a baroclinic cross-stream seiche in the Straits of Florida can also be observed using satellites (e.g., the Synthetic Aperture Radar satellite systems with short revisit time) or mapping via surface currents with a high-frequency radar. In addition, eddies in a body of water (e.g., Straits of Florida) that develop at the Gulf Stream front due to baroclinic cross-stream seiching can also be observed via remote sensing methods (e.g., satellites or mapping via surface currents with a high-frequency radar).

It can be useful to monitor atmospheric conditions when predicting the formation of intense hurricanes. For example, it has been reported that a strong vertical wind shear between the upper and lower atmosphere in the hurricane main development region, which expands from 10° N to 20° N and between the west coast of Africa to Central America, prevents organization of deep convection and thus inhibits the formation and intensification of hurricane. This shear is especially strong during El Nino events in the equatorial Pacific. The El Nino events are a part of the El Nino Southern Oscillation (ENSO) and are characterized by the ENSO index. The ENSO index reflects the monthly or seasonal fluctuations in the air pressure difference between Tahiti and Darwin (Australia) and is reported by NOAA.

The Gulf Stream front is the pronounced horizontal current velocity gradient that defines the western boundary of the Gulf Stream in the Straits of Florida.

Remote sensing, as used herein, refers to the measurement or acquisition of information by a recording device that is not in physical contact with the object (e.g., satellites and high-frequency radar).

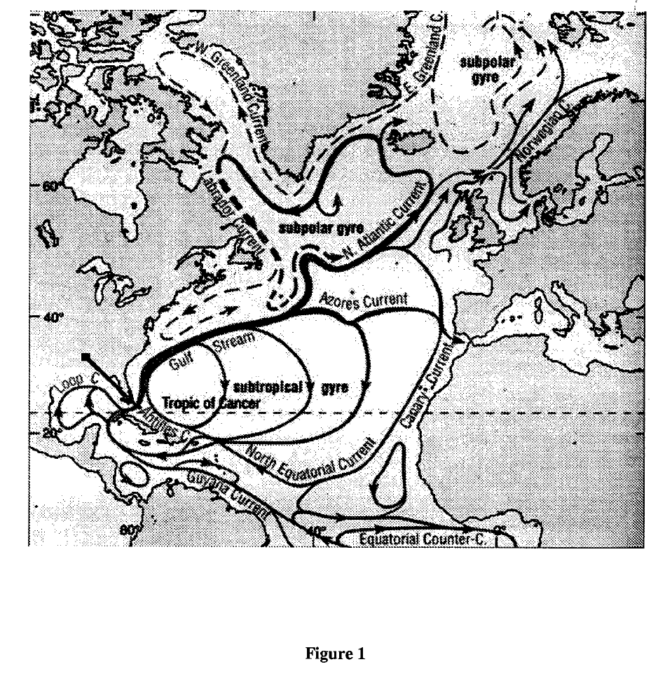

A pattern of the subtropical ocean gyre and western boundary current system are schematically shown in FIG. 1. The location of the mooring array is shown by an arrow. The mooring array has been operated to support the Navy field tests of autonomous underwater vehicles and to provide a complete seasonal cycle of the coastal circulation.

The importance of the state of the Atlantic Warm Pool on hurricane development has been described by Wang et al, J. Climate 2006, 19, 3011-3028 (the contents of which are incorporated herein by reference). It was shown that during 14 years of large Atlantic warm pools (e.g., sea surface temperatures (SST) warmer than 28.5° C.) there were 40 major hurricanes. In contrast, during 15 years of small Atlantic warm pools, there were only 24 major hurricanes.

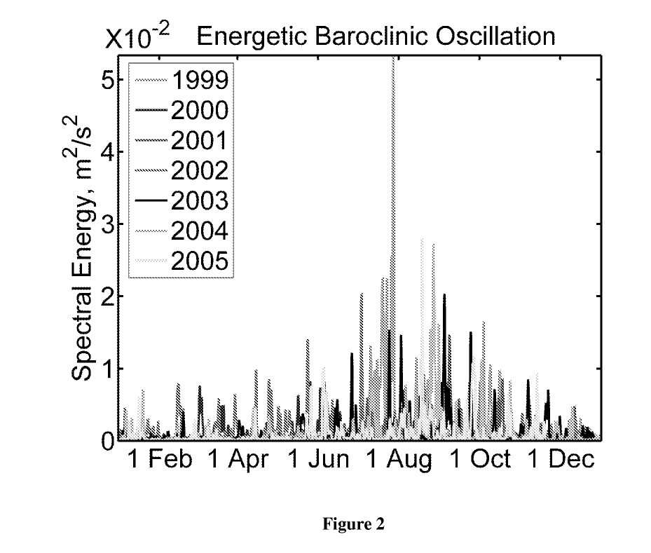

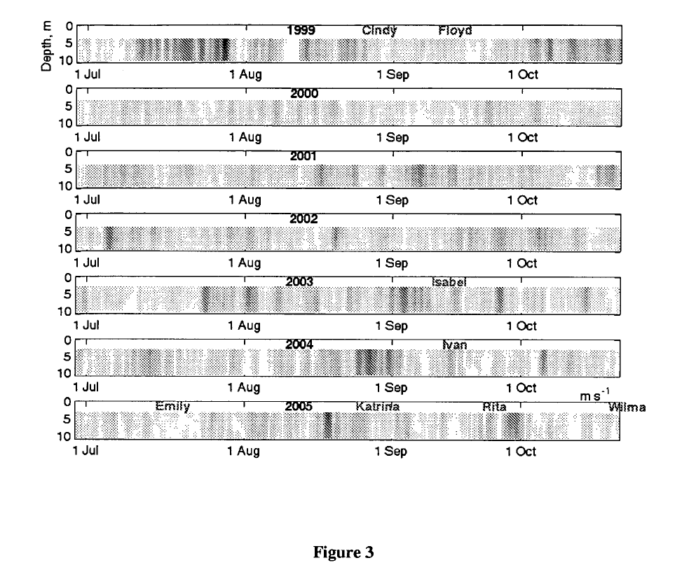

The velocity data reveal the quite intermittent nature of the 10 hr signal as well as its seasonal and interannual variability. These variations can be noted on the composite annual plot in FIG. 2. The spectral energy within the 8 to 12.5 hr wave period band shows a much more energetic regime during the summer than winter months. Interannual differences can be noted, as well, and are seen more clearly on the contour plots shown in FIG. 3.

A few cases of exceptionally strong 10 hr signals were observed during the summers of 1999, 2003, 2004, and 2005. Coincidentally, these were the hurricane seasons with increased hurricane activity. The equivalent Category 5 hurricanes that formed in the tropical Atlantic region are marked in FIG. 3. FIG. 3 indicates that the strongest internal oscillations in the Straits of Florida typically precede the formation of the strongest hurricanes. The lead time is approximately from one to four weeks.

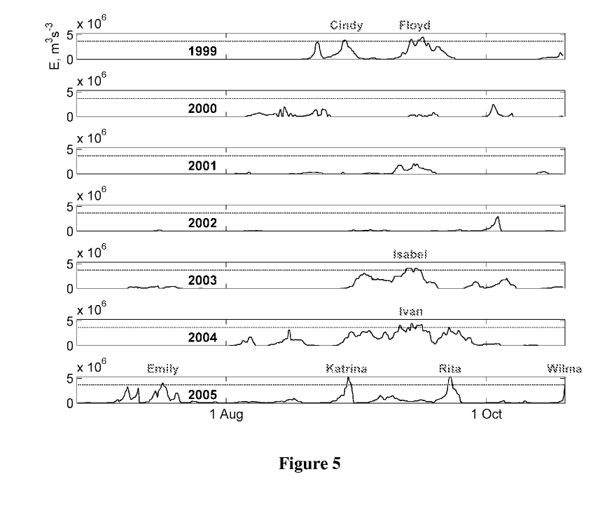

The equivalent Category 5 hurricane status is defined here based on the concept of power dissipation. The hurricane power dissipation is proportional to Vₘₐₓ³, where Vₘₐₓ is the maximum sustained surface wind speed at the conventional measurement height of 10 m. Maximum sustained surface winds in hurricanes are reported every 6 hours by the National Oceanographic and Atmospheric Administration's National Hurricane Research Center as part of the ‘best track’ tropical data set. The equivalent Category 5 status is then defined from inequality (ΣVₘₐₓ³)^{1/3}>155 mph, where the summation is made on all hurricanes and tropical storms reported in the Atlantic region for a 6-hour period. The net power dissipation by hurricanes during the 1999-2005 seasons is shown in FIG. 5.

Due to the Earth's rotation, the oceanic gyres tend to be displaced towards the western sides forming the western boundary current (FIG. 1). Western boundary currents are fast, narrow, and warm. Tropical cyclones develop and intensify over pools of warm water on the southern and southeastern flanks of the subtropical oceanic gyre. In the North Atlantic western boundary current system, most of the warm water transported by the North Equatorial Current that enters the Caribbean Sea through the passages between the islands of the Lesser Antilles, continuing through the Yucatan Channel into the Gulf of Mexico as the Loop Current and being exhausted through the Straits of Florida as the Gulf Stream and, near the eastern side of Bahamas, as the Antilles Current. The warm water—fuel for hurricanes—that cannot effectively be removed from the tropical ocean by ocean currents and normal atmospheric circulation piles up in the Caribbean Sea and the Gulf of Mexico and pours northwards through the Straits of Florida. If the pressure is anomalously strong, the Straits cannot pass it easily and ‘resonate’ at a natural internal seiching frequency (in analogy with a musical instrument).

The present invention is a method of identifying these resonations as a natural period of internal seiching (e.g., the 10-hour energetic internal oscillations) and using the intensity of internal oscillations at these seiching periods as indicators as to when too much warm water—“fuel” for hurricanes—is accumulated in the tropical Atlantic region, thereby serving as a sensor or mid-range forecast of the most dangerous hurricanes.

The 10 hr period internal oscillation in the Straits of Florida has been ascribed to internal (or baroclinic) cross-stream seiching developing between Florida and Bahamas. A natural period of internal seiching between Florida and Bahamas at the Dania Beach Fla. latitude known from previous studies is approximately 10 hours.

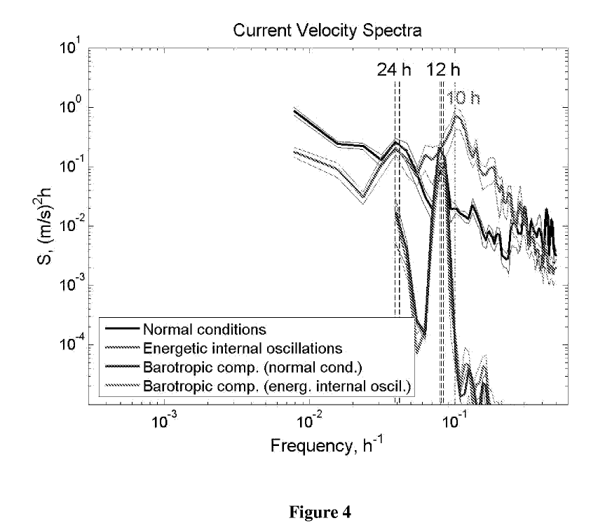

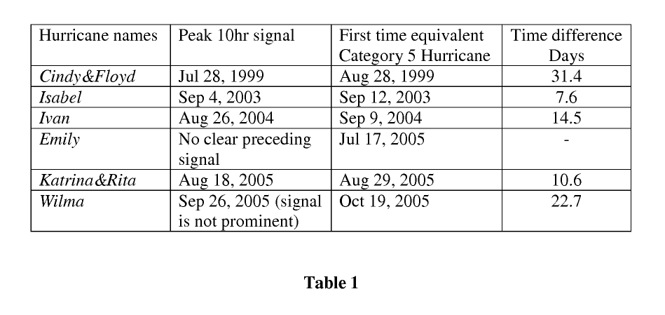

FIG. 4 shows velocity spectra for normal and energetic internal oscillation conditions in the Straits of Florida. The contribution of the barotropic (surface) tide to the velocity spectra both under normal and energetic conditions is also shown in FIG. 4. The velocity spectra (two upper bold curves) are compared to the spectra of barotropic tidal velocities (two lower bold curves) calculated from the sea level spectra using a long wave gravity theory. During normal conditions there are diurnal and semidiurnal peaks on the spectra, which appear to be due to barotropic tides. The energetic internal oscillations are associated with a prominent additional peak at a 10 hr period. This peak is due to internal (baroclinic) cross-stream seiching; it is not pronounced or not observed at all during normal conditions.

According to FIG. 3, which also contains time marks for the most destructive hurricanes, the energetic internal oscillations in the Straits of Florida are a predecessor of the equivalent Category 5 hurricanes. The time difference between the peak of energetic internal oscillations in the Straits of Florida and the first time a hurricane in the tropical Atlantic region achieved equivalent Category 5 status ranges from one to four weeks (Table 1).

Though adequate measurement of the excess heat content accumulated in the Atlantic Warm Pool area is difficult (satellite born data on SST or sea level anomalies do not provide exact characterization of the warm pool heat content; while, long term in-situ measurements in the Atlantic Warm Pool area are complicated by the presence of strong currents such as the North Equatorial Current, the Loop Current, and the Florida Current, which are associated with the western boundary current system), it is expected that the satellite data will help to pin-point the most probable location and time of the intense hurricane development.

Numerous modifications and variations of the present invention are possible in light of the above teachings. It is therefore to be understood that within the scope of the appended claims, the invention may be practiced otherwise that as specifically described herein.

What is claimed is:

1. A method of predicting the occurrence of intense hurricanes, comprising:
(a) recording internal oscillations in a body of water in or adjacent to a hurricane-prone region to determine its natural period of internal seiching;
(b) measuring the intensity of the internal oscillations in the body of water at its natural period of internal seiching; and,
(c) correlating the intensity measurements with the subsequent formation of hurricanes.

2. The method of claim 1, wherein the hurricane being predicted is an equivalent Category 5 hurricane or a series of equivalent Category 5 hurricanes.

3. The method of claim 1, wherein the body of water, comprises: a tropical warm water exhaust current.

4. The method of claim 3, wherein the body of water is the Straits of Florida.

5. The method of claim 1, wherein the natural period of internal seiching is about 10 hours.

6. The method of claim 1, wherein correlating is performed against a data set of at least 5 years of historical data from the same body of water.

7. The method of claim 6, wherein correlating is performed against a data set of at least 10 years of historical data from the same body of water.

8. The method of claim 1, further comprising:
(d) when intensity measurements indicate the potential formation of an intense hurricane, observing the atmospheric conditions in the hurricane-prone region to assist in determining the accuracy of the forecast.

9. The method of claim 8, wherein satellite information on the warm pool size and location is used to assist in pinpointing the time and location of the hurricane formation.

10. A method of obtaining data for predicting hurricanes, comprising:
(a) locating a body of water that internally oscillates in response to anomalous horizontal pressure gradients that develop in the upper layer of a tropical ocean during a hurricane season;
(b) placing sensors within the body of water that are capable of recording and transmitting data sufficient to measure internal seiching in the body of water;
(c) measuring internal oscillations in the body of water to determine its natural period of internal seiching; and,
(d) measuring the intensity of the internal oscillations in the body of water at its natural period of internal seiching.

11. The method of claim 10, further comprising:
(e) comparing the annual intensity of the natural period of internal seiching with previous years' annual intensity data to determine when a large increase in intensity is observed.

12. The method of claim 10, wherein the data, comprises: data from the body of water relating to current, sea level, temperature, and salinity.

13. A hurricane predictive data set, comprising: a computer readable medium, comprising: a data set derived by a process, comprising:
(a) recording internal oscillations in a body of water in a hurricane-prone region to determine its natural period of internal seiching;
(b) measuring the intensity of the internal oscillations in the body of water during its natural period of internal seiching; and,
(c) correlating the intensity measurements with the subsequent formation of hurricanes.

14. The data set of claim 13, wherein the hurricane is an equivalent Category 5 hurricane or a series of equivalent Category 5 hurricanes.

15. The data set of claim 13, wherein the body of water, comprises: a tropical warm water exhaust current.

16. The data set of claim 15, wherein the body of water is the Straits of Florida.

17. The data set of claim 13, wherein the natural period of internal seiching is about 10 hours.

18. The data set of claim 13, wherein correlating is performed against a data set of at least 5 years of historical data from the same body of water.

19. The data set of claim 18, wherein correlating is performed against a data set of at least 10 years of historical data from the same body of water.
